(19) United States
(12) Patent Application Publication
(10) Pub. No.: US 2002/0002239 A1
(43) Pub. Date: Jan. 3, 2002

(54) Binding of polyamides to proteins having SH3 or WW domains

(76) Inventors: Richard D. Tanaka, Moraga, CA (US); Paul J. Simpson, Fremont, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/741,778

(22) Filed: Dec. 19, 2000

Related U.S. Application Data
(60) Provisional application No. 60/173,622, filed on Dec. 29, 1999.

(51) Int. Cl. C08G 63/48

(52) U.S. Cl. 525/54.1

(57) ABSTRACT

Polyamides having heteroaromatic amino acid moieties (especially pyrrole amino acid and/or imidazole amino acid moieties) form complexes with proteins having SH3 or WW domains. As a result of complex formation, the biological activity of such proteins can be inhibited.

### BACKGROUND OF THE INVENTION

1. Field of the Invention

This invention relates to the binding of polyamides to proteins having SH3 or WW domains, to the complexes so formed, to methods of forming such complexes, and to uses of such complexes.

2. Description of Related Art

A large number of biologically important proteins have an SH3 (src homology region 3) domain. Examples include eukaryotic and prokaryotic protein kinases that regulate signal transduction pathways, viral replication proteins (e.g., HIV nef protein), proteins used for cellular adhesion and motility, and regulatory enzymes (e.g., phospholipase C, phosphoinositol 3-kinase, phosphodiesterase 4A). Peptides having proline-rich regions that are in a polyproline type II helical conformation bind to SH3 domain-containing proteins.

Another large group of biologically important proteins are characterized by having WW domains, which are highly conserved protein motifs of 38-40 amino acids. Such proteins, which include structural, regulatory, and signaling proteins, are exemplified by membrane-associated guanylate kinase (MAG-1), yes-associated protein (YAP), neural protein FE65, ubiquitin protein ligase (Nedd4), formin-binding protein (FBP11), IQGAP proteins, and peptidyl-prolyl cis/trans isomerase (Pin 1).

The biological activity of an SH3- and WW-domain containing protein can be regulated—in particular, inhibited—by binding a ligand to the SH3 or WW domain. It is thus desirable to develop synthetic compounds having such binding characteristics. Nguyen et al., in Science, Dec. 11, 1998, 282, 2088-2092, describe the design of N-substituted synthetic peptide inhibitors for SH3- and WW-domain containing proteins.

This specification describes alternative synthetic compounds for binding to SH3 and WW domains.

### BRIEF SUMMARY OF THE INVENTION

In a first aspect, the invention provides a method of forming a complex between a protein having an SH3 or a WW domain and a polyamide, comprising bringing together, under complex forming conditions, a protein having an SH3 or a WW domain and a polyamide comprising at least two heteroaromatic amino acid moieties —NH—Het—C(═O)—, where Het is a heteroaromatic moiety separating the —NH— and —C(═O)— groups by two or more atoms.

In a second aspect, the invention provides a complex between an SH3 or a WW domain containing protein and a polyamide comprising at least two heteroaromatic amino acid moieties —NH—Het—C(═O)—.

In a third aspect, the invention provides a method of modulating the biological activity of an SH3— or a WW-domain containing protein, comprising contacting the protein with a complex-forming amount of a polyamide comprising at least two heteroaromatic amino acid moieties —NH—Het—C(═O)—, thereby modulating the biological activity of the protein.

In a fourth aspect, the invention provides a method of screening a library of compounds for the presence of a compound having affinity for an SH3 or a WW domain in a protein, comprising:

(a) contacting a library of compounds with a protein having an SH3 or a WW domain and a complex-forming amount of a polyamide comprising at least two heteroaromatic amino acid moieties —NH—Het—C(═O)—, the polyamide being capable of forming a complex with the protein; and

(b) comparing the amount of binding of the polyamide to the protein in absence of the library to the amount of the binding of the polyamide to the protein in the presence of the library.

The protein and the polyamide can be contacted with the library in the form of a pre-formed complex, or they can be added individually.

### BRIEF DESCRIPTION OF THE DRAWING(S)

FIG. 1 shows the inhibition of 3T3 mouse fibroblast cell proliferation by a polyamide according to this invention.

FIG. 2 shows the inhibition of peripheral blood mononuclear cells by a polyamide according to this invention.

### DETAILED DESCRIPTION OF THE INVENTION

An amino acid is an organic molecule having both an amino (—NH₂) group and a carboxylic acid (—CO₂H) group. A polyamide is a polymer comprising amino acid moieties chemically linked by amide (—CONH—) linkages, with the carboxylic acid group of one amino acid combining with the amino group of an adjacent amino acid to form an amide linkage. In preferred polyamides of this invention, the amino acid moieties have 5-membered heteroaromatic rings and are selected from the group consisting of

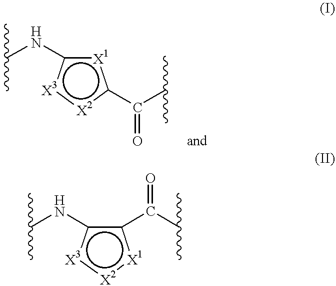

wherein X¹, X², and X³ are each independently selected from —O—, —S—, —NR¹—, —N═, and —CR²═, with the proviso that in each five-membered heteroaromatic ring, only one of X¹, X², and X³ is —O—, —S—, or —NR¹—. Each R¹ is independently H or a C₁ to C₁₀ alkyl, alkenyl, or alkynyl group. Each R² is independently H, Cl, F, Br, I, OH, NO₂, or a C₁ to C₁₀ alkyl, alkenyl, or alkynyl group. In each 5-membered heteroaromatic ring, the circle indicates the presence of two double bonds joining ring vertices, depending on the nature of X¹, X², and X³.

Preferably, the polyamide comprises N-heteroaromatic amino acid moieties. In the context of formulae I and II, this means that at least one of X¹, X², and X³ is —NR¹— or —N═.

Exemplary suitable five-membered heteroaromatic rings include imidazole, pyrrole, pyrazole, furan, oxazole, isoxazole, thiazole, thiophene, furazan, 1,2,3-thiadiazole, 1,2,4-thiadiazole, 1,2,5-thiadiazole, 1,3,4-thiadiazole, 1,2,3-triazole, 1,2,4-triazole, 1,3,4-oxadiazole, and 1,2,4-oxadiazole rings.

Where R¹ or R² is a C₁ to C₁₀ alkyl, alkenyl, or alkynyl group, it can be straight chain, branched, or cyclic. One or more hydrogens in R¹ or R² can be replaced by a substituent such as hydroxy; oxo (═O); primary, secondary, or tertiary amine; quaternary ammonium (e.g., —NH₂, —NH(CH₃), —N(CH₃)₂, -N(CH₃)₃⁺); alkoxy (e.g., methoxy, ethoxy); acyl (e.g., —C(═O)CH₃); amide (e.g., —NHC(═O)CH₃); thiol; thioether (e.g., —SCH₃); sulfoxide; sulfonamide (e.g., —SO₂NHCH₃); halogen (e.g., F, Cl); nitro; and the like. Further, one or more carbons in R¹ or R² can be replaced by one or more heteroatoms, so that R¹ or R² can contain ether (—O—), thioether (—S—), sulfoxide (—SO—), sulfone (—SO₂—), amide (—C(O)NH—), sulfonamide (—SO₂NH—), amine (—NH—, —N(CH₃)—, etc.), and like groups. Exemplary R¹ and R² groups include methyl, trifluoromethyl (in the instance of R²), ethyl, acetyl, methoxy (in the instance of R²), methoxyethyl, ethoxyethyl, aminoethyl, hydroxyethyl, propyl, hydroxypropyl, cyclopropyl, isopropyl, 3-(dimethylamino)propyl, butyl, s-butyl, isobutyl, t-butyl, pentyl, cyclopentyl, vinyl, allyl, ethynyl, propynyl, and the like.

Preferably, R¹ is H or CH₃. Preferably, R² is H, CH₃, or OH.

Among the amino acid moieties having 5-membered heteroaromatic rings, preferred ones are the pyrrole amino acid moiety and the imidazole amino acid moiety, respectively

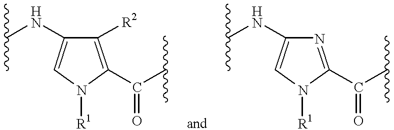

where R¹ and R² are as previously defined.

Especially preferred are those in which R¹ is methyl and R² is H, that is, the N-methylpyrrole amino acid moiety (conventionally referred to by the shorthand notation Py) and the N-methylimidazole amino acid moiety (conventionally referred to by the shorthand notation Im), respectively represented by the formulae

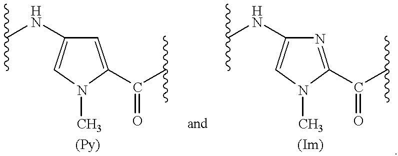

Subsequent discussion in this specification will be with specific reference to such preferred N-methylpyrrole and N-methylimidazole amino acid moieties, but it is to be understood that the invention is not so limited.

Additionally, a polyamide of this invention can have moieties derived from other amino acids, such as aliphatic amino acids (including but not limited to α-amino acids), aromatic amino acids, other heteroaromatic amino acids, and chemical modifications thereof. Exemplary other amino acid moieties include prolyl and β-alanyl.

A preferred polyamide can comprise pyrrole amino acid moieties only, or imidazole amino acid moieties only, or a combination of the two.

The pyrrole and imidazole amino acid moieties can be adjacent to each other or separated by one or more moieties derived from other amino acids. As illustrative sequences, two or more pyrrole (or imidazole) amino acid moieties can appear consecutively, or pyrrole and imidazole amino acid moieties can alternate, or they can be separated from each other by one or more moieties derived from other amino acids.

Preferably, the polyamide contains a sequence of 3 to 4 consecutive N-methylpyrrole or N-methylimidazole amino acid moieties. Peptide sequences that bind to SH3 domains are characterized by the motif PZZP, where P represents proline and Z represent another α-amino acid.

The polyamides can be linear, or cyclic in structure.

Where the polyamide is non-cyclic, the terminal amino and carboxyl groups can be left as such, or they can be functionalized by reaction with a suitable capping agent for reasons such as modifying solubility, attaching a detectable label, altering lipophilicity, enhancing cellular permeability, improving binding affinity and/or specificity, and the like. For example, the terminal amino group can be amidated with a carboxylic acid (e.g., imidazole carboxylic acid) and the terminal carboxyl group can be amidated with an amine. Alternatively, a terminal amino or carboxy group that is not needed for further polymer chain extension can be replaced by an unreactive group such as H or CH₃.

The polyamide can bind to an SH3 or WW domain in a 1:1 mode or, alternatively, in a 2:1 mode, in which two polyamide molecules are aligned side-by-side within a single domain binding site, in a manner similar to how such polyamides have been shown to bind to the minor groove of double-stranded DNA (see, e.g., WO 98/50582 (1998)), depending on the width and depth of the binding site in the SH3 or WW domain.

The polyamides can further comprise aliphatic amino acids, particularly ω-amino aliphatic amino acids, to provide a hairpin turn (where the amino acid moieties interact with the binding site in a paired or double-stranded configuration), to form cyclic polyamides, to modify the lipophilicity of the polyamide, to provide for a shift in the spacing of the amino acid moieties in the polyamide relative to specific topological feature in the binding site, or to improve or optimize binding. Exemplary amino acids useful in one or more of these regards include glycine, α-alanine, β-alanine, 2,4-diaminobutyric acid, and γ-aminobutyric acid. Generally, the longer chain amino acids serve the role of providing for hairpin turns and/or of closing the polyamide to form a ring.

For the purpose of monitoring complex formation, detectable labels can be attached to the polyamide. Suitable detectable labels include those conventional in the art, such as fluorescers (e.g., dansyl, fluorescein, Texas red, isosulfan blue, ethyl red, malachite green), chemiluminescers, particles (e.g., magnetic particles, colloidal particles, gold particles), light sensitive bond forming compounds, chelating compounds, and the like.

Lipophilicity of the polyamide can be modified by attaching lipophilic groups such as cholesterol, fatty acids, fatty alcohols, sphigomyelins, cerebrosides, and the like, or saccharides.

Attached groups such as detectable labels and lipophilicity modifiers can be attached to the carboxy or amino terminus of the polyamide or as a pendant group along the polyamide chain, or both.

Polyamides of this invention can be made by solid-state or solution-phase synthetic methods. Such methods and the starting materials and intermediates therefor are generally known in the art and have been described in W. S. Wade, Ph.D. Thesis (1989), California Institute of Technology, Pasadena, Calif., USA; Wade et al., Biochemistry 1993, 32, 11385-11389; Wade et al., J. Am. Chem. Soc., 1992, 114, 8783-8794; Herman et al., J. Am. Chem. Soc., 1999, 121, 1121-1129; Baird et al., J. Am. Chem. Soc., 1996, 118, 6141-6146; Mrksich et al., J. Am. Chem. Soc., 1994, 116, 7983-7988; Dervan, U.S. Pat. No. 6,143,901 (2000); Dervan et al., WO 98/37067 (1998); Dervan, WO 98/49142 (1998); Baird et al., WO 00/40605 (2000); Dervan et al., WO 98/37066 (1998); and Dervan et al., U.S. Pat. No. 6,090,947 (2000); the disclosures of which are incorporated herein by reference.

A preferred polyamide comprises the sequence

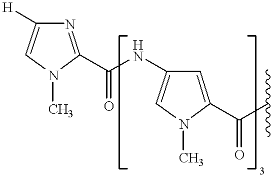

Employing the shorthand convention described above, this sequence can be referred to as H-ImPy₃, with the amino-terminal group replaced by an H. Alternatively, the partial sequence can be viewed as a Py₃ sequence capped at the amino end by N-methylimidazole-2-carboxylic acid. A specific example of a polyamide having such partial sequence is polyamide IA

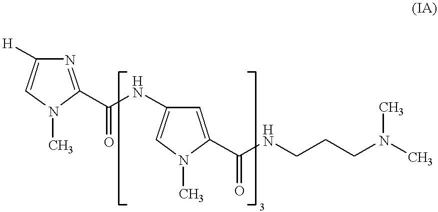

The synthesis of polyamide IA from nitro acid IV (Taylor et al., Tetrahedron, 1984, 40 (3), 457-465) has been reported in the literature (W. S. Wade, Ph.D. Thesis (1989), California Institute of Technology) and is summarized in Scheme 1.

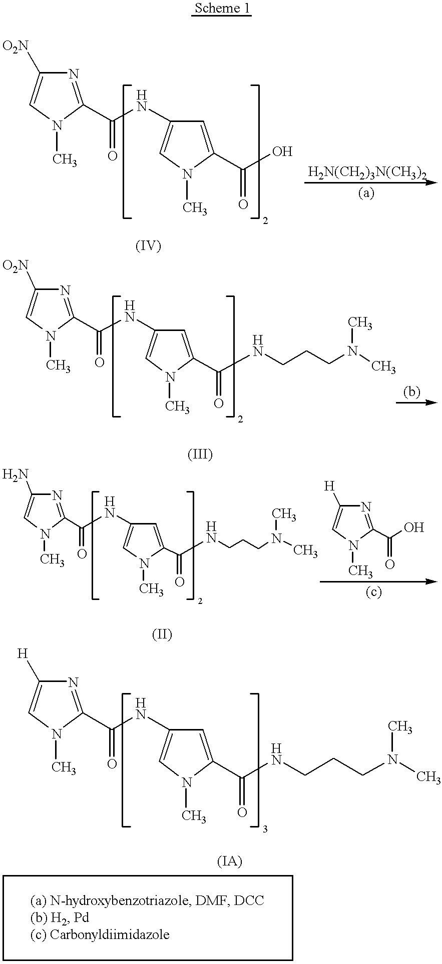

The target proteins are SH3— or WW-domain containing proteins, particularly the SH3 and WW domains thereof. It is known that these domains preferentially bind proline-rich peptide regions that are in a polyproline type II helical conformation. Polyamides having pyrrole and/or imidazole amino acid moieties resemble proline-rich α-amino acid peptides and bind to SH3 and WW domains. Preferably, the polyamides of this invention have a generally crescent shape, complementary to the shape of the SH3 or WW domains to which they bind.

Examples of SH3 domain proteins that can be complexed by polyamides in accordance with this invention include protein kinases (eukaryotic or prokaryotic) that regulate signal transduction pathways, viral replication proteins (e.g., HIV nef protein), proteins used for cellular adhesion and motility, and regulatory enzymes.

Examples of WW domain proteins that can be complexed by polyamides in accordance with this invention include structural, regulatory, and signaling proteins, are exemplified by membrane-associated guanylate kinase (MAG-1), yes-associated protein (YAP), neural protein FE65, ubiquitin protein ligase (Nedd4), formin-binding protein (FBP11), IQGAP proteins, and peptidyl-prolyl cis/trans isomerase (Pin 1).

Many diseases are caused by the over-activity or undesired activity of one protein or another. Where the responsible protein is an SH3 or a WW domain-containing protein, the invention provides a means for modulating the biological function associated the protein through complex formation with a polyamide. In this manner, it is possible to treat cancer, inflammation, metabolic disease, and infectious disease. Where the infective agent is a virus, therapeutic treatment can target various different viral proteins and/or their interactions, including virion-cell receptor interactions, reverse transcriptase interactions, integrase activity, protease activity, virion assembly, and viral regulatory factors. Alternatively, the SH3 or WW domain containing protein can be a component of the signal cascade giving effect to a signal initiated by the protein whose activity is to be suppressed or reduced. By inhibiting the SH3/WW domain protein, the signal cascade is interrupted and the biological activity of the protein initiating the signal cascade is suppressed.

The invention can be further understood by reference to the following examples, which are provided by means of illustration, and not limitation.

### EXAMPLE 1

Platelet derived growth factor (PDGF) has been shown to stimulate the growth of 3T3 BALB/c mouse fibroblast cells. Handler et al., J. Biol. Chem. 1990, 265, 3669. SH3 domain proteins are components of the protein kinase intracellular signaling pathway for PDGF stimulated cell proliferation, and, therefore, inhibition of the stimulatory effect by an inhibitor is indicative of the inhibitor's ability to bind to SH3-domain containing proteins in the signaling pathway.

Polyamide IA was tested as an inhibitor on the PDGF-stimulated proliferation of 3T3 BALB/c cells.

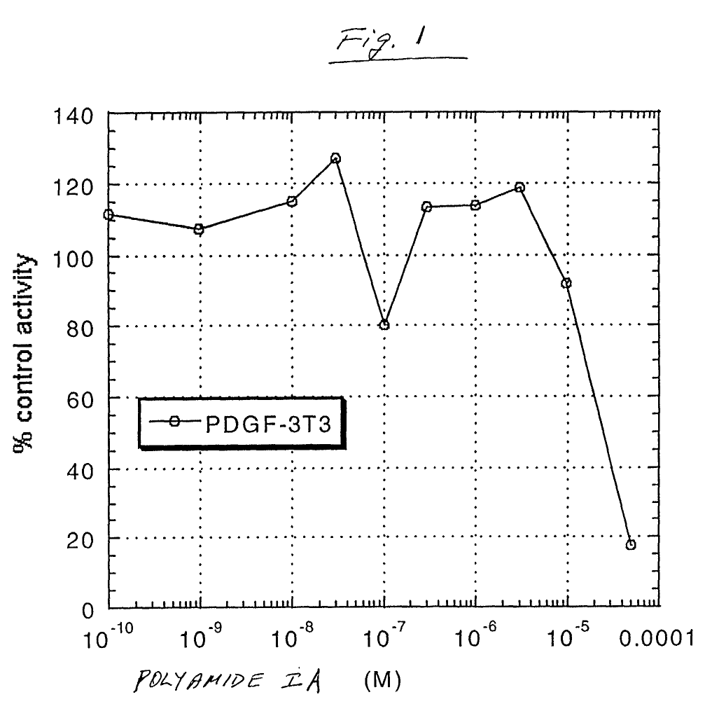

The proliferation of the cells in the presence of a stimulatory concentration of PDGF (3 ng/mL) was assayed via the incorporation of [³H]-thymidine into DNA. Increasing amounts of polyamide IA were added, leading to the results shown in FIG. 1. Compared against a control (no added polyamide IA), polyamide IA shows marked inhibitory activity with an IC₅₀ (concentration producing inhibition of 50% of the maximum) of 2.8 μM.

The inhibition of PDGF stimulation of cellular growth via inhibition of SH3 domain containing proteins in the PDGF signaling pathway is therapeutically useful in inhibiting restenosis following angioplasty (Bilder et al., Circulation, 1999, 99, 3292-3299); oncology (blocking angiogenesis); artherosclerosis; lung fibrosis; kidney fibrosis; and fibrosis in general.

### EXAMPLE 2

Peripheral blood mononuclear cells (PBMC's) are another type of cell whose proliferation is stimulatable, in this instance by phytohemaglutinin (PHA). Gougerot-Pocilado et al., Immunology, 1988,64:281. SH3 domain proteins are components of the protein kinase intracellular signaling pathway for PHA stimulated cell proliferation. Thus, effectiveness in inhibiting PHA stimulated cell proliferation is indicative of the inhibitor's ability to bind to SH3 domains of the proteins.

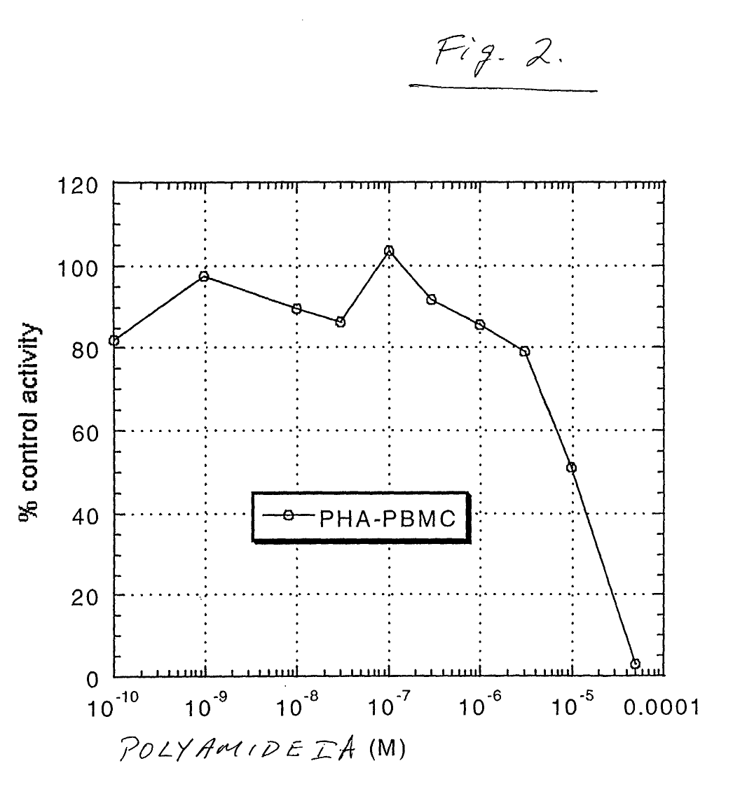

Polyamide IA was again the test polyamide molecule. The proliferation of PBMC's in the presence of a stimulatory concentration of PHA (2 μg/mL) was monitored via the incorporation of [³H]-thymidine into DNA, using liquid scintillation techniques. The results are presented in FIG. 2. They show that polyamide IA exerts a marked inhibitory effect, with an IC₅₀ of 8.7 μM.

Therapeutically, inhibition of PHA stimulation of cell growth is useful in oncology (leukemia) and in the treatment of fibrosis and atheroslerosis.

### EXAMPLE 3

The ability of polyamide IA to protect PBMC's from infection by HIV-1 Rojo was tested. HIV-1 nef protein is an SH3 -domain containing protein that is required for viral replication, so that ability to protect PBMC's from infection is indicative of SH3-domain binding.

PBMC's were isolated from donors who were seronegative for HIV and HBV by leukophoresis and Ficoll-Hypaque gradient. They were re-suspended to 10⁷/mL in RPMI 1640 with 1.5% fetal bovine serum (FBS), 2 mM L-glutamine, 4 μg/mL PHA-P, and allowed to incubate for 48-72 hr at 37° C. After incubation, they were re-suspended in RPMI 1640 with 15% FBS, 2 mM L-glutamine, 100 U/mL penicillin, 100 μg/mL streptomycin, 10 μg/mL gentamycin, and 20 U/mL rhu IL-2. The PBMC's were maintained at a concentration of 1-2×10⁶/mL with biweekly changes of medium until use.

At least two normal donor blood cells were pooled. 96 well round bottom plates were used with 50 μL of cells (100,000 cells per well), 100 μL of test compound, and 50 μL of virus stock. (The amount of virus used was that which gave complete cell kill at 6 days after infection in a control.) After incubating for 7 days, a reverse transcriptase assay was performed.

Generally, the reverse transcription assay can be summarized as follows: Reverse Transcriptase Activity (RT) was measured in cell-free supernantants. Tritiated thymidine triphosphate (³H-TTP, from New England Nuclear) was re-suspended in distilled water at 5 Ci/mL. Poly rA and oligo dT were prepared in a stock stored at −20° C. The RT reaction buffer was prepared fresh daily and consisted of 125 microliter of 1 M EGTA, 125 microliter distilled water, 110 microliters of 10% SDS, 50 microliters of 1 M Tris (pH 7.4), 50 microliter 1 M DTT, and 40 microliters of 1 M MgCl₂. These three solutions were mixed together in a ratio of 2 parts TTP, 1 part poly rA:oligo dT, and 1 part reaction buffer. Ten microliters of this reaction mixture was placed in a round bottom microtiter plate and 15 microliters of virus containing supernatant was added and mixed. The plate was incubated at 37 C for 60 minutes. After reaction, the volume was spotted onto pieces of DE81 paper, washed five times for 5 minutes each in a 5% sodium phosphate buffer, twice for 1 minute in distilled water, twice for one minute in 70% ethanol, then dried. Radioactivity was determined by liquid scintillation counting.

Cytotoxicity was measured separately, in a separate virus-free plate, using an XTT assay. XTT (2,3-bis(2-methoxy-4-nitro-5-sulfophenyl-)-5-[(phenylamino)carbonyl]-2H-tetrazolium hydroxide) is metabolized by the mitochondrial enzymes of metabolically active cells to a soluble formazan product, allowing rapid quantitative analysis of cytotoxicity. An XTT solution was prepared daily as a stock of 1 mg/mL in phosphate buffered saline (PBS). Phenazine methsulfate (PMS) solution was prepared at 15 mg/mL in PBS and stored in the dark at −20° C. XTT/PMS stock was prepared immediately before use by diluting the PMS solution 1:100 into PBS and adding 40 μL/mL of XTT solution. 50 μL of this solution was added to each well and cells were incubated for 4 hr at 37° C. Formazan was measured spectrophotometrically at 450 nm.

The results on the effectiveness of polyamide IA are presented in Table I.

TABLE I

| Run | Inhibitory Concentra- | Toxic Concentration | Therapeutic Index |
|---|---|---|---|
| No. | tion IC₅₀ (μM) | TC₅₀ (μM) | TI (TC₅₀/IC₅₀) |
| 1 | 8.2 | 63.1 | 7.7 |
| 2 | 12.7 | 55.0 | 3.3 |

### EXAMPLE 4

The attachment of HIV-1 to human cells requires specific co-receptors that are involved in the activation of the cells as well as the entry into the cells after activation. Tec and Lck are cellular tyrosine kinases that contain SH3 domains and are required for receptor signaling in T cells.

The ability of polyamide IA to inhibit the attachment and entry of HIV-1 into HeLa cells was tested using the P-galactosidase assay described below. Two separate experiments gave IC₅₀'s of 26.6 and 52.1 micromolar, indicating that polyamide IA interferes with HIV-1 infection through inhibition of cellular activation involving SH3 domain proteins.

The viral attachment assay was performed with the HeLa CD4 LTR β-gal cells available from the AIDS Research and Reference Repository. HeLa CD4 LTR β-gal cells are routinely cultured with the required selection antibiotics. Twenty-four hours prior to initiation of the assay, the cells were trypsinized, counted and 10,000 cells placed in a 0.2 cm well in media without selection antibiotics. At 24 hours, medium was removed and compound in medium was placed on the cells and incubated for 15 to 30 minutes at 37° C. A known titer of virus was then added to the wells and the incubation was continued for 1 hour. At the end of the incubation period, the wells were washed 6 times with medium and the cultures were continued for 48 hours. At 48 hours the medium was removed and β-galactosidase enzyme expression was determined by chemiluminescence as described in the manufacturers instructions (Tropix Gal-screen, Bedford, Mass.). This chemiluminescent method uses a single solution, containing lysis components and chemiluminescent substrates, to detect activity in a single step. Compound was also tested for cytotoxicity by XTT dye reduction.

### EXAMPLE 5

U1 cells latently infected with HIV-1 were treated with polyamide IA, with and without added tumor necrosis factor (TNFα) as an activator. U1 cells are a human T cell line latently infected with HIV-1. Grb-2 protein is an SH3-domain containing protein that binds to the TNFα receptor and allows cell activation and expression of the latent HIV infection.

U1 cells were obtained from the AIDS Research and Reference Reagent Program. Twenty four hours prior to assay the cells were split 1:2 in culture media (RPMI 1640 medium (no phenol red) with 10% Fetal Bovine Serum (heat inactivated), 2 mM L-glutamine, 100 U/mL penicillin, 100 ug/mL streptomycin and 10 ug/mL gentamycin. At the time of assay, 2500 to 5000 cells were placed in 96 well plates with media containing 5 ng/ml TNFα and the test compound. Cultures were incubated for three days and cell free supernatants were harvested for determination of RT activity. Compound toxicity was determined by XTT dye reduction. Virus replication was assessed in cell-free supernatants by Reverse Transcriptase (RT) activity.

The results are presented in Table II.

TABLE II

| TNF α | IC₅₀ (μM) | TC₅₀ (μM) | TI |
|---|---|---|---|
| None | >200 | 171 | n/a |
| Added | 1.50 | 144 | 96 |

The results indicate that polyamide IA is a very potent inhibitor of SH3-domain proteins required for the activation of a latent HIV-1 infection.

### EXAMPLE 6

ACH-2 cells latently infected with HIV-1 were tested as in Example 5. ACH-2. ACH-2 cells are a human T-cell line having a latent HIV-1 infection. Again, Grb-2 is involved in the activation pathway of the latent infection.

ACH-2 cells were obtained from the AIDS Research and Reference Reagent Program. Twenty four hours prior to assay the cells were split 1:2 in culture media (RPMI 1640 medium (no phenol red) with 10% Fetal Bovine Serum (heat inactivated), 2 mM L-glutamine, 100 U/mL penicillin, 100 ug/mL streptomycin and 10 ug/mL gentamycin. At the time of assay, 2500 to 5000 cells were placed in 96 well plates with media containing 5 ng/ml TNFα and the test compound. Cultures were incubated for three days and cell free supernatants were harvested for determination of RT activity. Compound toxicity was determined by XTT dye reduction. Virus replication was assessed in cell-free supernatants by Reverse Transcriptase (RT) activity.

The results are presented in Table III.

TABLE III

| TNF α | IC₅₀ (μM) | TC₅₀ (μM) | TI (=TC₅₀/IC₅₀) |
|---|---|---|---|
| None | 1.49 | 120.7 | 81 |
| Added | 44 | 116 | 2.7 |

The results indicate that polyamide IA is a very potent inhibitor of ACH-2 cellular activation, through a mechanism that involves inhibition of viral replication in a basal state.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions herein relate to specific embodiments of the invention, it is to be understood that where a specific feature is disclosed in the context of a particular figure or embodiment, such feature can also be used, to the extent appropriate, in the context of another figure or embodiment, in combination with another feature, or in the invention in general.

Further, while the present invention has been particularly described in terms of certain preferred embodiments, the invention is not limited to such preferred embodiments. Rather, the scope of the invention is defined by the appended claims.

What is claimed is:

1. A method of forming a complex between a protein having an SH3 or a WW domain and a polyamide, comprising bringing together, under complex forming conditions, a protein having an SH3 or a WW domain and a polyamide comprising at least two heteroaromatic amino acid moieties —NH—Het—C(═O)—, where Het is a heteroaromatic moiety separating the —NH— and —C(═O)— groups by two or more atoms.

2. A method according to claim 1, wherein the heteroaromatic amino acid moieties are selected from the group consisting of 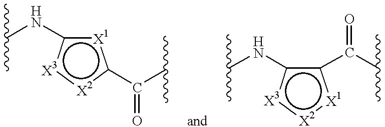
wherein
X¹, X², and X³ are each independently selected from —O—, —S—, —NR¹—, —N═, and —CR²═, with the proviso that in each five-membered heteroaromatic ring, only one of X¹, X², and X³ is —O—, —S—, or —NR¹—;
each R¹ is H or a C₁ to C₁₀ alkyl, alkenyl, or alkynyl group; and
R² is H, Cl, F, Br, I, OH, NO₂, or a C₁ to C₁₀ alkyl, alkenyl, or alkynyl group.

3. A method according to claim 1, wherein the heteroaromatic amino acid moieties are selected from the group consisting of

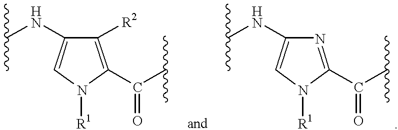

4. A method according to claim 1, wherein the heteroaromatic amino acid moieties are selected from the group consisting of

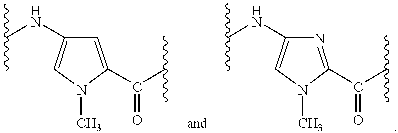

5. A method according to claim 1, wherein the polyamide contains a sequence of 3 to 4 consecutive heteroaromatic amino acid moieties selected from the group consisting of

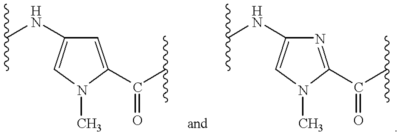

6. A method according to claim 1, wherein the polyamide contains the sequence

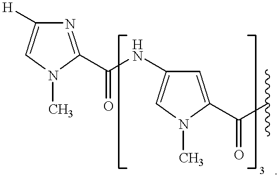

7. A method according to claim 1, wherein the protein is a protein kinase, a viral replication protein, a cellular adhesion protein, a cellular motility protein, a regulatory enzyme, HIV nef protein, a membrane-associated guanylate kinase (MAG-1 ), a yes-associated protein (YAP), a neural protein FE65, an ubiquitin protein ligase (Nedd4), a formin-binding protein (FBPL11), an Fe65 protein, an IQGAP protein, or a peptidyl-prolyl cis/trans isomerase (Pin 1).

8. A complex between an SH3 or WW domain containing protein and a polyamide comprising at least two heteroaromatic amino acid moieties —NH—Het—C(═O)—, where Het is a heteroaromatic moiety separating the —NH— and —C(═O)— groups by two or more atoms.

9. A complex according to claim 8, wherein the heteroaromatic amino acid moieties are selected from the group consisting of 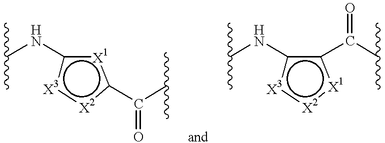
wherein
X¹, X², and X³ are each independently selected from —O—, —S—, —NR¹—, —N═, and —CR²═, with the proviso that in each five-membered heteroaromatic ring, only one of X¹, X², and X³ is —O—, —S—, or —NR¹—;
each R¹ is H or a C₁ to C₁₀ alkyl, alkenyl, or alkynyl group; and
R² is H, Cl, F, Br, I, OH, NO₂, or a C₁ to C₁₀ alkyl, alkenyl, or alkynyl group.

10. A complex according to claim 8, wherein the heteroaromatic amino acid moieties are selected from the group consisting of

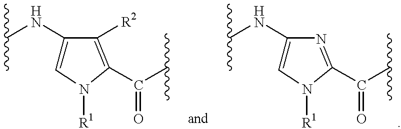

11. A complex according to claim 8, wherein the hetero aromatic amino acid moieties are selected from the group consisting of

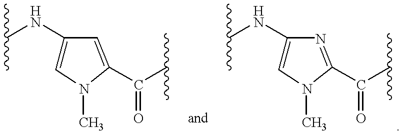

12. A complex according to claim 8, wherein the polyamide contains a sequence of 3 to 4 consecutive heteroaromatic amino acid moieties selected from the group consisting of

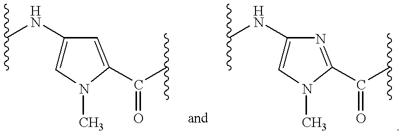

13. A complex according to claim 8, wherein the polyamide contains the sequence

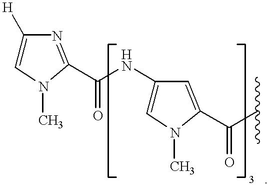

14. A complex according to claim 8, wherein the protein is a protein kinase, a viral replication protein, a cellular adhesion protein, a cellular motility protein, a regulatory enzyme, HIV nef protein, a membrane-associated guanylate kinase (MAG-1), a yes-associated protein (YAP), a neural protein FE65, an ubiquitin protein ligase (Nedd4), a formin-binding protein (FBP11), an Fe65 protein, an IQGAP protein, or a peptidyl-prolyl cis/trans isomerase (Pin 1).

15. A method of modulating the biological activity of an SH3- or a WW-domain containing protein, comprising contacting the protein with a complex-forming amount of a polyamide comprising at least two heteroaromatic amino acid moieties —NH—Het—C(═O)—, where Het is a heteroaromatic moiety separating the —NH— and —C(═O)— groups by two or more atoms, thereby modulating the biological activity of the protein.

16. A method according to claim 15, wherein the heteroaromatic amino acid moieties selected from the group consisting of 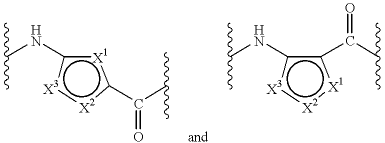
wherein
X¹, X², and X³ are each independently selected from —O—, —S—, —NR¹—, —N═, and —CR²═, with the proviso that in each five-membered heteroaromatic ring, only one of X¹, X², and X³ is —O—, —S—, or —NR¹—;
each R¹ is H or a C₁ to C₁₀ alkyl, alkenyl, or alkynyl group; and
R² is H, Cl, F, Br, I, OH, NO₂, or a C₁ to C₁₀ alkyl, alkenyl, or alkynyl group.

17. A method according to claim 15, wherein the heteroaromatic amino acid moieties are selected from the group consisting of

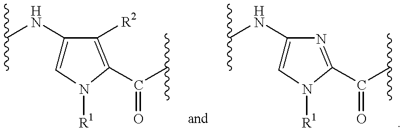

18. A method according to claim 15, wherein the heteroaromatic amino acid moieties are selected from the group consisting of

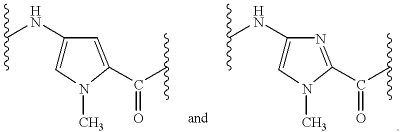

19. A method according to claim 15, wherein the polyamide contains a sequence of 3 to 4 consecutive heteroaromatic amino acid moieties selected from the group consisting of

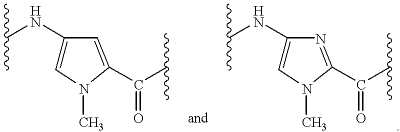

20. A method according to claim 15, wherein the polyamide contains the sequence

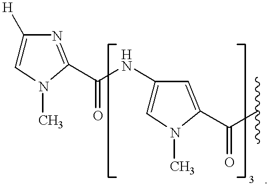

21. A method according to claim 15, wherein the protein is a protein kinase, a viral replication protein, a cellular adhesion protein, a cellular motility protein, a regulatory enzyme, HIV nef protein, a membrane-associated guanylate kinase (MAG-1), a yes-associated protein (YAP), a neural protein FE65, an ubiquitin protein ligase (Nedd4), a formin-binding protein (FBP11), an Fe65 protein, an IQGAP protein, or a peptidyl-prolyl cis/trans isomerase (Pin 1).

22. A method according to claim 15, wherein the protein is a component of the protein kinase intracellular signaling pathway in PDGF stimulated cell proliferation.

23. A method according to claim 15, wherein the protein is a component of the protein kinase intracellular signaling pathway in PHA stimulated cell proliferation.

24. A method according to claim 15, wherein the protein is Tec or Lck tyrosine kinase or Grb-2 protein.

25. A method according to claim 15, wherein the protein is a viral protein.

26. A method of screening a library of compounds for the presence of a compound having affinity for an SH3 or a WW domain in a protein, comprising:
(a) contacting a library of compounds with a protein having an SH3 or a WW domain and a complex-forming amount of a polyamide comprising at least two heteroaromatic amino acid moieties —NH—Het—C(═O)—, where Het is a heteroaromatic moiety separating the —NH— and —C(═O)— groups by two or more atoms, the polyamide being capable of forming a complex with the protein; and
(b) comparing the amount of binding of the polyamide to the protein in absence of the library to the amount of the binding of the polyamide to the protein in the presence of the library.

27. A method according to claim 26, wherein the heteroaromatic amino acid moieties are selected from the group consisting of 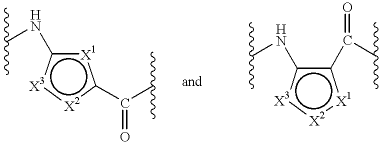
wherein
X¹, X², and X³ are each independently selected from —O—, —S—, —NR¹—, —N═, and —CR²═, with the proviso that in each five-membered heteroaromatic ring, only one of X¹, X², and X³ is —O—, —S—, or —NR¹—;
each R¹ is H or a C₁ to C₁₀ alkyl, alkenyl, or alkynyl group; and
R² is H, Cl, F, Br, I, OH, NO₂, or a C₁ to C₁₀ alkyl, alkenyl, or alkynyl group.

28. A method according to claim 26, wherein the heteroaromatic amino acid moieties are selected from the group consisting of

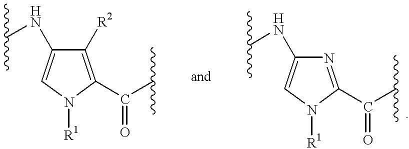

29. A method according to claim 26, wherein the heteroaromatic amino acid moieties are selected from the group consisting of

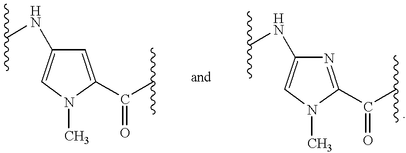

30. A method according to claim 26, wherein the polyamide contains a sequence of 3 to 4 consecutive heteroaromatic amino acid moieties selected from the group consisting of

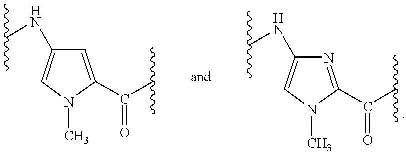

31. A method according to claim 26, wherein the polyamide contains the sequence

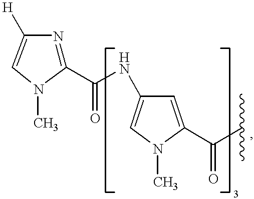

32. A method according to claim 26, wherein the protein and the polyamide are contacted with the library as a pre-formed complex.

33. A method according to claim 26, wherein the protein and the polyamide are individually contacted with the library.
